(19) United States
(12) Patent Application Publication
(10) Pub. No.: US 2023/0264521 A1
(43) Pub. Date: Aug. 24, 2023

(54) ELIMINATION OF MANUAL RESET UPON TIRE INSTALLATION IN TIRE MANAGEMENT SYSTEMS

(71) Applicant: SENSATA TECHNOLOGIES, INC., ATTLEBORO, MA (US)

(72) Inventors: WILLIAM D. STEWART, ANTRIM (GB); JONATHAN WILGAR, CARRICKFERGUS (GB); BHUPINDER SAINI, LONDON (GB); KEVIN DICKSON, COOKSTOWN (GB)

(21) Appl. No.: 18/005,580

(22) PCT Filed: Jul. 28, 2021
(86) PCT No.: PCT/US2021/043442

§ 371 Date: Jan. 13, 2023

Related U.S. Application Data
(60) Provisional application No. 63/057,993, filed on Jul. 29, 2020.

(51) Int. Cl. B60C 11/24

(52) U.S. Cl. CPC B60C 11/246; B60C 2019/004

(57) ABSTRACT

Methods, apparatuses, systems, devices, and computer program products for eliminating the need for a manual tread wear system reset in a tire management system are disclosed. In a particular embodiment, a method to eliminate the need for a manual tread wear system reset in a tire management system includes a vehicle control system (VCS) of a vehicle receiving a tire identifier for a tire corresponding to a tire sensor. In this embodiment, the vehicle control system determines, based on the tire identifier, whether the tire is in an unused state and calculates, based on whether the tire is in an unused state, a tread depth for the tire.

### TECHNICAL FIELD

The present disclosure relates to tire management systems. More particularly, this disclosure relates to eliminating the need for a manual tread wear system reset in a tire management system.

### BACKGROUND

It is possible to estimate the degree of tread wear on a tire by determining the circumference of the tire and comparing it with the circumference of the tire when it was new. For example, in known systems, methods of determining tire tread wear are based on determining the rolling radius of a tire, which is indicative of the tire's circumference. Other methods estimate tread wear by comparing the number of wheel rotations/revolutions measured over a fixed distance with the expected rotations of a tire with full tread. These approaches require vehicle sensors that must be calibrated to specific tire characteristics and components of the vehicle. Furthermore, these circumferential-based tire wear monitoring systems must be reset upon the installation of a new or different tire.

### BRIEF DESCRIPTION OF THE DRAWINGS

FIG. 1 illustrates an example of a tire management system.

FIG. 2 illustrates a block diagram of an example vehicle control system (VCS)

FIG. 3 illustrates a block diagram of an example tire monitoring sensor (TMS).

FIG. 4 shows an example of an initial growth phase for a tire.

FIG. 5 is a flowchart of an example method to eliminate the need for a manual tread wear system reset in a tire management system according to embodiments of the present disclosure.

FIG. 6 is a flowchart of another example method to eliminate the need for a manual tread wear system reset in a tire management system according to embodiments of the present disclosure.

FIG. 7 is a flowchart of another example method to eliminate the need for a manual tread wear system reset in a tire management system according to embodiments of the present disclosure.

FIG. 8 is a flowchart of another example method to eliminate the need for a manual tread wear system reset in a tire management system according to embodiments of the present disclosure.

FIG. 9 is a flowchart of another example method to eliminate the need for a manual tread wear system reset in a tire management system according to embodiments of the present disclosure.

FIG. 10 is a flowchart of another example method to eliminate the need for a manual tread wear system reset in a tire management system according to embodiments of the present disclosure.

### SUMMARY OF INVENTION

Methods, apparatuses, systems, devices, and computer program products for eliminating the need for a manual tread wear system reset in a tire management system are disclosed. In a particular embodiment, a method to eliminate the need for a manual tread wear system reset in a tire management system includes a vehicle control system (VCS) of a vehicle receiving a tire identifier for a tire corresponding to a tire sensor. In this embodiment, the vehicle control system determines, based on the tire identifier, whether the tire is in an unused state and calculates, based on whether the tire is in an unused state, a tread depth for the tire.

As will be explained in greater detail below, a VCS is able to determine whether a tire is in an unused state using a tire identifier. Depending on whether the tire is in an unused state, a tread depth or tread wear algorithm may be modified or adjusted to account for an expected growth phase found in previously unused tires.

### DETAILED DESCRIPTION

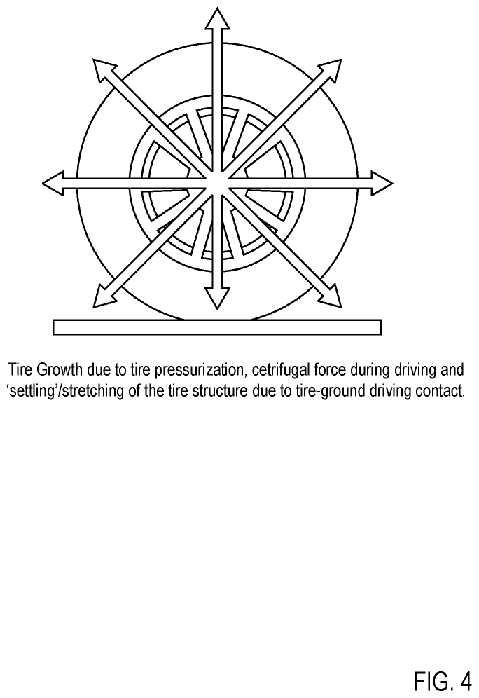

When a new, unused tire is installed on a wheel rim and put in use, the tire exhibits a permanent increase in its natural outer circumference due to tire expansion. This expansion is the result of various conditions, including tire pressurization, centrifugal force exhibited during driving, and settling/stretching of the tire structure due to tire-ground contact during driving. (See FIG. 4) This expansion phase is tire specific.

Due to changes in tire circumference/radius/diameter as a result of tread depletion or tire growth, solutions that use the analysis of a tire's circumference to infer tread depth or changes in tread depth (tire wear) also require knowing when a new tire has been installed, otherwise a manual reset at the vehicle is required, as in existing indirect tire pressure monitoring systems. This manual reset is required to put the tread wear algorithm into a new ‘tire learning phase’.

Additionally, a tire may be refitted to a rim in a used state and as such, the used tire has previously experienced a reduction in tire depth. Indirect tread wear systems are required to know if the tire is in a new or used state, and if in a used state, the system is required to know the degree of tread wear on the used tire.

The methods, apparatuses, devices, and computer program product disclosed herein allows for the portability of tire from vehicle to vehicle without the need for a manual tread wear/depth system reset. These methods provide solutions that enable a tire circumference based indirect tread wear system to automatically determine 1) if a new tire has been installed; and 2) the degree of tread wear (or tread depth) on a newly installed used tire.

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

A tire mounted sensor can be used to measure and analyze many different parameters that a tire is exposed to and report these parameters via radio frequency (RF), Bluetooth Low Energy (BLE), or others means to the vehicle. Traditionally, valve-based sensors transmit parameters such as pressure and temperature as well as the sensor's own unique ID. These parameters are transmitted to a receiving device on a vehicle, such as an electronic control unit (ECU) or body control module (BCM), or to a smart device, such as a smart phone. With the tire monitoring technology migrating to sensor mounting location in the tire's inner lining, additional parameters can also be monitored, such as accelerometry and actual tire temperature.

In addition to the sensor ID, the tire's unique ID and/or Department of Transportation (DOT) code can also be transmitted by the sensor to a receiving device. By receiving the tire's unique ID, the tread wear/depth monitoring system can determine if the tire is new to the vehicle and in an unused state, and therefore uses this information as an indication to reset the tread wear algorithm for that wheel/tire location of the system. Resetting the tread wear algorithm will indicate to an indirect tread monitoring system that the tire is in an unused state. The tire ID and DOT code can be programmed into the sensor (via BLE or other means) at any stage but maybe typically programmed to the tire mounted sensor during the installation of the sensor in the tire. In the case of valve mounted sensors, the tire ID and DOT code can be programmed into the sensor on installation of the tire on the wheel rim. In addition to the tread wear algorithm reset that is initiated by the reception of a new tire ID or DOT code, an indication of tread depth can also be transmitted by the sensor to the receiving device.

Bi-directional communications such as BLE can enable a function where each tire sensor can retain a log of its inferred tread depth/tread (based on previous tire usage), the number of tire rotations/revolutions, distance travelled, and where the data is generated at a vehicular level (tread wear indicator systems, wheel speed sensors, GPS) and transmitted to each wheel sensor. At ignition off, the data (tread depth/tread wear, number of tire rotations/revolutions, distance travelled) is transmitted from the vehicle ECU to each sensor—relating to the vehicle's previous journey. Each sensor then adds this incremental value from the previous journey to its own accumulative value. At drive off, as well as tire ID and/or DOT code indication, the sensor additionally transmits the stored value relating to usage (tread depth/tread, number of tire rotations/revolutions, distance travelled).

In the case where a previously used tire is installed on a vehicle, the indirect tread monitoring system can detect that this is a newly fitted tire, reset the tread wear algorithm and additionally offset the algorithm with the value for tread wear or tire usage, and reconfigure or eliminate the tire growth phase of the tread wear algorithm,

The methods disclosed are not limited to tire mounted or embedded sensor technology. However, in the case of valve mounted or wheel rim mounted sensor technology, the tire must remain with the valve/wheel sensor during its life in order to maintain the log of tire usage.

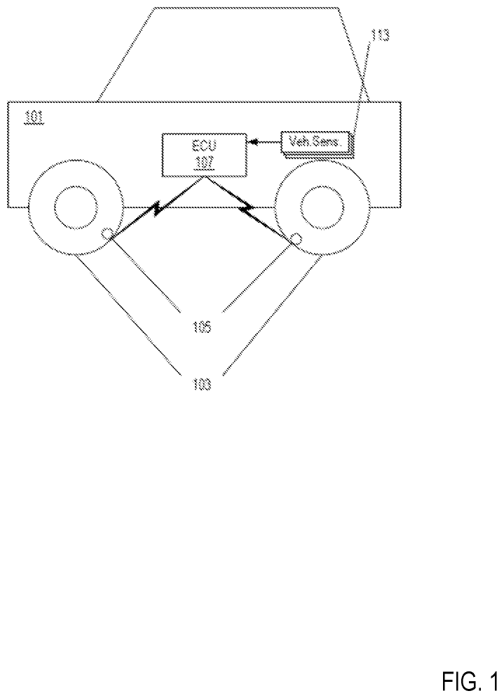

Exemplary methods, systems, apparatuses, and computer program products for eliminate the need for a manual tread wear system reset in a tire management system in accordance with the present disclosure are described with reference to the accompanying drawings, beginning with FIG. 1.

For further explanation, FIG. 1 sets forth a diagram of an apparatus of a tire management system according to embodiments of the present disclosure. The apparatus of FIG. 1 includes a vehicle (101) equipped with tires (103) that include tire sensors (e.g., wheel/tire mounted sensors (TMSs)) (105). While the embodiment of FIG. 1 shows two tires each equipped with a tire sensor (105), it will be understood that as few as one, and as many as all, of the tires (103) of the vehicle (101) may include a tire sensor (105). The vehicle of FIG. 1 further includes a vehicle control unit (107), commonly referred to as the vehicle's “computer,” which may be an electronic control unit (ECU) as shown in FIG. 1. Each tire sensor (105) is equipped with a wireless transceiver for bidirectional wireless communication with the ECU (107). The ECU is similarly equipped with a wireless transceiver for bidirectional wireless communication with each of the TMSs (105). The bidirectional wireless communication may be realized by low power communication technology such as Bluetooth Low Energy or other low power bidirectional communication technology that is intended to conserve energy consumed.

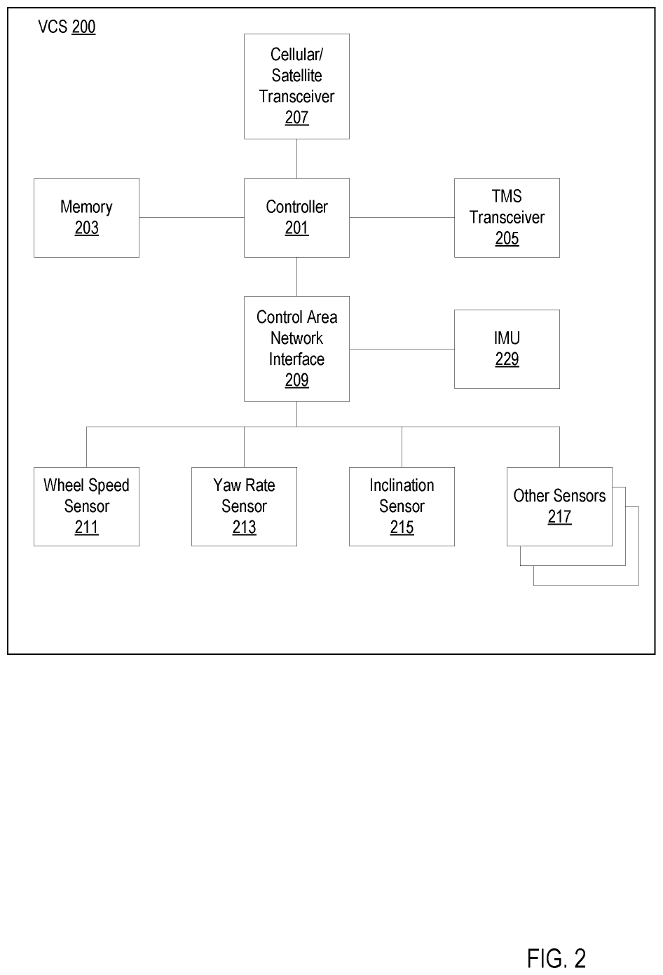

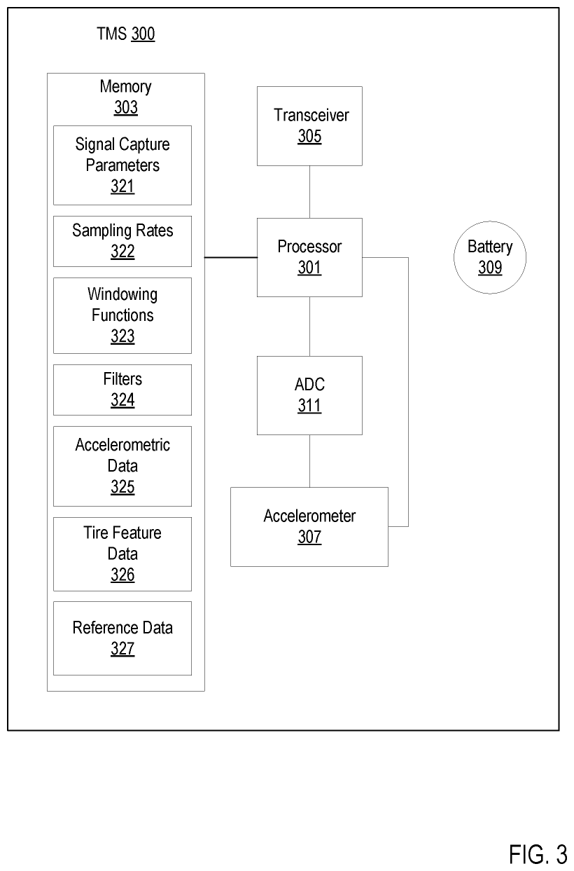

For further explanation, FIG. 2 sets forth a diagram of an exemplary vehicle control system (VCS) (200) according to embodiments of the present disclosure. The VCS (200) includes a controller (201) coupled to a memory (203). The controller (201) is configured to obtain sensor readings related to vehicle operating conditions, as well as data from sources external to the vehicle, and provide configuration parameters to a tire monitoring sensor (TMS), such as TMS (300) (see FIG. 3). The controller may include or implement a microcontroller, an Application Specific Integrated Circuit (ASIC), a digital signal processor (DSP), a programmable logic array (PLA) such as a field programmable gate array (FPGA), or other data computation unit in accordance with the present disclosure. The sensor readings and data, as well as tire feature data received from the TMS, may be stored in the memory (203). The memory (203) may be a non-volatile memory such as flash memory. For example, the VCS (200) may obtain vehicle operating condition data, such as sensor readings from sensors on-board the vehicle.

For bidirectional wireless communication with a TMS, the VCS (200) includes a TMS transceiver (205) coupled to the controller (201). In one embodiment, the TMS transceiver (205) is a Bluetooth Low Energy transmitter-receiver. In other embodiments, the TMS transceiver (205) may be other types of low power radio frequency communication technology that is intended to conserve energy consumed in the TMS. The VCS (200) may further include a transceiver (207) for cellular terrestrial communication, satellite communication, or both. In some examples, the VCS (200) communicates with a cloud-based server to transmit sensor readings and tire feature data, and to receive an analytical result.

The VCS (200) may further comprise a controller area network (CAN) interface (209) for communicatively coupling vehicle sensors and devices to the controller (201). Of particular relevance to the present disclosure, the CAN interface (209) couples a wheel speed sensor (211), a yaw rate sensor (213), an inclination sensor (215), and other sensors (217), to the controller (201). The wheel speed sensor (211) measures the rotational angular speed of the wheel, e.g., in radians per second. The yaw rate sensor (213) may be used to measure the yaw-induced acceleration of the vehicle, for example, when the vehicle is maneuvering a curve, which will influence the magnitude of loading on each tire. The yaw rate sensor (213) may also provide information on the shear forces on the tire where it contacts the road. The inclination sensor (215) may detect longitudinal and/or transverse inclination of the vehicle. The wheel speed sensor (211), the yaw rate sensor (213), and the inclination sensor (215) transmit respective readings to the controller (201). In some examples, an inertial measurement unit (IMU) (229) is configured to measures a vehicle's specific force, angular rate, and/or orientation using a combination of accelerometers, gyroscopes, and/or magnetometers.

For further explanation, FIG. 3 sets forth a diagram of an exemplary tire monitoring sensor (TMS) (300) according to embodiments of the present disclosure. The TMS (300) includes a processor (301). The processor may include or implement a microcontroller, an Application Specific Integrated Circuit (ASIC), a digital signal processor (DSP), a programmable logic array (PLA) such as a field programmable gate array (FPGA), or other data computation unit in accordance with the present disclosure.

The TMS (300) of FIG. 3 also includes a memory (303) coupled to the processor (301). The memory may store signal capture parameters (321) received from the VCS (200) or a TCU. The memory (303) may store a sampling rates table (322) of sampling rates at which the ADC (311) sampled accelerometric signals data from the accelerometer (307). The processor (301) may configure the ADC (311) in accordance with a stored sampling rate. The memory (303) may also store a windowing function table (323) of windowing functions for identifying road strikes from accelerometric data. The memory (303) may also store a filter table (324) of filter frequency bands with which to filter an accelerometric waveform. The memory (303) may also store accelerometric data (325), including a raw digital signal sampled from the accelerometer (307) by the ADC (311) and a processed accelerometric waveform processed by the processor (301). The memory (303) may also store tire data (326), such as a TMS identifier, a tire identifier (e.g., manufacturer make and model), manufacturer specifications for tire dimension (e.g., radius, circumference, width, aspect ratio, tread depth), a tire stiffness parameter, a tire mass parameter, and the like. The memory (303) may also store reference data (327) such as a reference circumference, a reference radius, a reference tire thickness, and/or a reference tread depth programmed by the manufacturer or received from the VCS (200) or a TCU after an initial measurement of the tire when the tire is in a substantially original condition (i.e., when the tire is new).

For bidirectional wireless communication with the VCS (200), the TMS (300) of FIG. 3 includes a transceiver (305) coupled to the processor (301). In one embodiment, the transceiver (305) is a Bluetooth Low Energy transmitter-receiver. In other embodiments, the transceiver (305) may be other types of low energy bidirectional communication technology that is intended to conserve energy consumed in the TMS (300). The TMS (300) may transmit accelerometric data, tire velocity data, measured tire dimension data and reference data to the VCS (200) or a TCU via the transceiver (305). In an alternative embodiment, the TMS (300) includes a unidirectional transmitter configured to transmit data to the VCS (200) or a TCU.

The accelerometer (307) of FIG. 3 may also be an acceleration sensor, an accelerometric device, a shock sensor, a force sensor, a microelectromechanical systems (MEMs) sensor, or other device that is similarly responsive to acceleration magnitude and/or to changes in acceleration, such that a tire revolution may be determined from the time between detected ground strike events. For example, an accelerometer senses acceleration in the radial plane (z-plane), lateral plane (y-plane), and/or tangential plane (x-plane), and outputs an electric pulse signal responsive to sensed acceleration, including but not limited to signals indicative of ground strikes. In an embodiment, the accelerometer (307) is configurable with an accelerometer range, a wheel speed parameter, or other vehicle parameter provided by the VCS (200). For example, g-offset can be determined via wheel speed sensor or another vehicle parameter and used to capture and process signals faster. Accelerometers may have a selectable range of forces they can measure. These ranges can vary from ±1 g up to ±700 g. An example range of an accelerometer is ±200 g. The accelerometer range may be configured based on wheel speed, for example, ±150 g at a low speed, ±250 g at a medium speed, and ±500 g at a high speed. Typically, the smaller the range, the more sensitive the readings will be from the accelerometer.

The TMS (300) of FIG. 3 also includes an analog to digital converter (ADC) (311) that receives the electric pulse signals from the accelerometer (307) and sampled accelerometric signals them according to a sampling rate. The ADC (311) converts the raw analog signals received from the accelerometer (307) into a raw digital signal that is suitable for digital signal processing.

The TMS (300) of FIG. 3 also includes a battery (309) connected to a power bus (not shown) to power the transceiver (305), the processor (301), the ADC (311), the accelerometer (307), and the memory (303). The TMS (300) may be powered by other sources alternative to or in addition to the battery (309), such as an energy harvester or other power source.

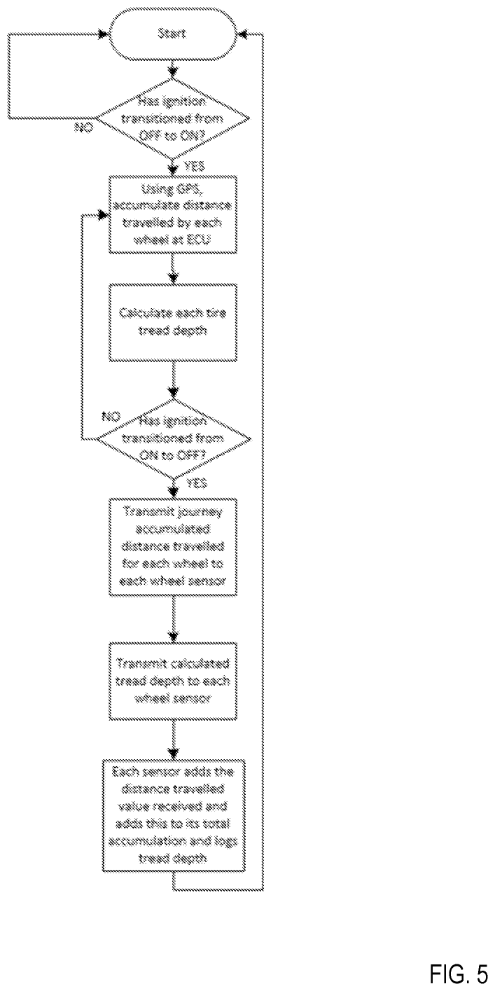

For further explanation, FIG. 5 sets forth a diagram of a flow chart that recites an example method disclosed herein. Using bi-directional communications, each tire sensor can retain a log of the number of tire rotation/revolutions and/or tire tread depth. Using data from the vehicle's GPS or other means, the vehicle ECU may determine the distance travelled by each tire to calculate the tire's tread depth. In a particular embodiment, a vehicle control unit (e.g., the ECU) is configured to determine that the ignition of a vehicle has transitioned from OFF to ON. In response to determining that the ignition has transitioned from OFF to ON, the method determines, from the GPS, the accumulated distance travelled by each wheel. The ECU calculates the tread depth for each tire based on the accumulated distance travelled. (The ECU could also accumulate, from wheel speed sensors, the total number of rotations for use in determining the tire's tread depth.)

The method continues by the ECU determining whether the ignition has transitioned from ON to OFF. In response to determining that the ignition has transitioned from ON to OFF, the ECU transmits the prior journey's accumulated distance travelled for each wheel, to each wheel sensor. The ECU further transmits the calculated tread depth to each wheel sensor. Each sensor then adds the distance travelled value received, adds this to its total accumulation, and logs the tread depth.

In the case of tire mounted sensors, this invention permits the tire to be moved to other vehicles with similar systems and still maintain a record of the distance travelled and the tread depth, thus eliminating the need for a manual reset of the tread wear algorithm. This invention is not limited to tire mounted (or embedded) sensor technology. However, in the case of valve mounted or wheel rim sensor technologies, the tire must remain with the valve/wheel sensor during its life to maintain the log of data.

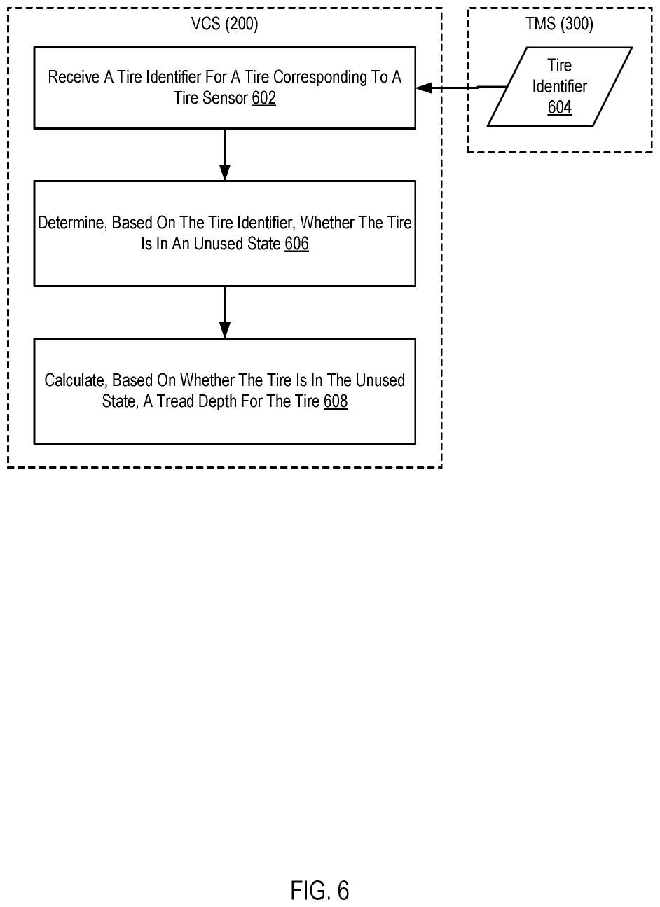

For further explanation, FIG. 6 sets forth a flowchart of an example method to eliminate the need for a manual tread wear system reset in a tire management system according to some embodiments of the present disclosure. The method of FIG. 6 may be implemented, for example, in a vehicle control system (VCS) (200), an ECU, or another component of a vehicle as can be appreciated. The method of FIG. 6 includes receiving (602) a tire identifier (604) for a tire corresponding to a tire sensor (e.g., a TMS (300)).

The tire identifier (604) is a numeric, alphanumeric, or other identifier that uniquely identifies a particular tire. The tire identifier (604) may include, for example, a DOT code, a Serialized Global Trade Item Number (SGTIN) such as SGTIN-96, or another identifier as can be appreciated. In some embodiments, the tire identifier (604) is received from the tire sensor corresponding to the tire. In other embodiments, the tire identifier (604) is received from a tire mounted sensor mounted to the tire (e.g., inside the tire). In other embodiments, the tire identifier (604) is received from a wheel-mounted sensor (e.g., mounted to a wheel or rim to which the tire is installed). The tire identifier (604) may be received using BLE, RF, or another wireless communications channel as can be appreciated. In some embodiments, the tire identifier (604) is received on a start or ignition of the vehicle. For example, the VCS (200) queries or otherwise detects the tire sensors of tires of the vehicle and receives, in response, the tire identifiers (604) stored in each of the tire sensors.

In some embodiments, the tire identifier (604) is transmitted to or otherwise stored in the tire sensor by a remote device such as a handheld device or other mobile computing device (e.g., a smartphone, tablet, and the like). The tire may have the tire identifier (604) written, inscribed, or otherwise indicated on a surface of the tire. For example, the tire identifier (604) may be inscribed on the tire, encoded as a Quick Response (QR) code or barcode, or otherwise indicated on the tire. A scanner, camera, or other input device of the computing device may capture or detect the tire identifier (604) and transmit the tire identifier (604) to the tire sensor for storage. As another example, the tire identifier (604) may be encoded in a Radio Frequency Identifier (RFID) tag of the tire. The computing device may detect the tire identifier (604) using an RFID reader and then transmit the tire identifier (604) for storage. The computing device may also accept a manual input of the tire identifier (604) using a keyboard, touch screen, or other input device. The computing device may transmit the tire identifier (604) using BLE, RF, or other wireless or wired communications channels as can be appreciated.

The tire identifier (604) may be stored in the tire sensor at a particular time depending on where the tire sensor is affixed relative to the tire. For example, for a wheel-mounted sensor, the tire identifier (604) may be stored in the tire sensor when the tire is installed on the wheel. Where the tire sensor is a tire-mounted sensor (e.g., a valve-mounted sensor or other tire-mounted sensor), the tire identifier (604) may be stored in the tire sensor when or after the tire sensor is installed in the tire itself.

The method of FIG. 6 also includes determining (606), based on the tire identifier (604), whether the tire is in an unused state. A tire is considered in an unused state when it has not been subject to driving or other road conditions. As will be described in further detail below, a tire sensor or the VCS (200) may store usage data indicating one or more usage metrics for a particular tire, such as an estimated tread depth, an amount of estimated tread wear, a distance traveled, or a number of rotations or revolutions for the tire. Where such usage data is stored in the VCS (200), determining (606) whether the tire is in an unused state may include loading or accessing the usage data corresponding to the tire identifier (604) and determining if one or more of the usage metrics exceeds a threshold (e.g., zero). For example, a non-zero distance traveled, a non-zero amount of tread wear, and the like may indicate that the tire is not in an unused state. In some embodiments, the usage data may include an indicator or flag indicating whether the tire is in an unused state. Where such usage data is stored in the tire sensor, the usage data may be received from the tire sensor with or separate from the tire identifier (604). In other embodiments, as will be described in further detail below, determining (606) whether the tire is in an unused state may include querying a remote database (e.g., via a cellular, WiFi, or other network connection) with the tire identifier (604).

The method of FIG. 6 also includes calculating (608), based on whether the tire is in the unused state, a tread depth for the tire. One skilled in the art will appreciate that, in some embodiments, instead of a tread depth, an estimated amount of tread wear may be calculated. As is set forth above, a tire that is an unused state will experience an initial growth phase during its initial usage during driving. Thus, tread wear or tread depth calculation algorithms will vary depending on whether the tire is in an unused state in order to account for this initial growth phase. Accordingly, calculating (608) the tread depth for the tire based on whether the tire is in the unused state includes calculating (608) the tread depth accounting for an initial grown phase if the tire is in the unused state. The tread depth or tread wear may be calculated using any tread depth or tread wear algorithm as can be appreciated by one skilled in the art. In some embodiments, the tread depth is calculated in response to the vehicle stopping, parking, or transitioning to an ignition off state. In some embodiments, the tread depth for a given tire is calculated based on one or more usage metrics for the tire measured by the tire sensor. Accordingly, in some embodiments, calculating (608) the tread depth may include receiving these usage metrics from the tire sensor. The tread depth may also be stored based on other metrics stored in the tire sensor but not directly measured by the tire sensor, such as previously calculated or stored tread depth or tread wear values. The tread depth may also be calculated based on various metrics measured or calculated by the VCS (200) such as a distance traveled as measured by an odometer or GPS sensor, or other metrics as can be appreciated.

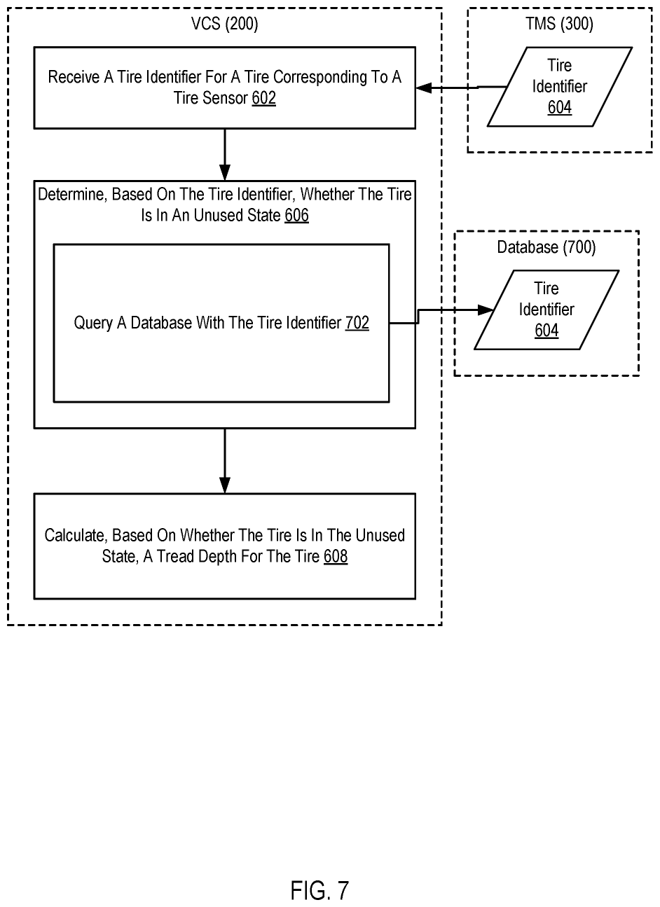

For further explanation, FIG. 7 sets forth a flowchart of an example method to eliminate the need for a manual tread wear system reset in a tire management system according to some embodiments of the present disclosure. The method of FIG. 7 is similar to FIG. 6 in that the method of FIG. 7 includes receiving (602) a tire identifier (604) for a tire corresponding to a tire sensor; determining (606), based on the tire identifier (604), whether the tire is in an unused state; and calculating (608), based on whether the tire is in the unused state, a tread depth for the tire.

The method of FIG. 7 differs from FIG. 6 in that determining (606), based on the tire identifier (604), whether the tire is in an unused state includes querying (702) a database (700) with the tire identifier (604). The database (700) may include, for example, a database (700) implemented in a remotely disposed computing device or execution environment, such as a remote server, a cloud computing environment, and the like. As an example, the database (700) may store, for a given tire identifier (604), various usage metrics including previously calculated tread depth or tread wear values submitted to the database (700) by the VCS (200) of the vehicle or of another vehicle, or from another device. The database (700) may also store a flag or indication as to whether the tire is in an unused state. The database (700) may also store baseline or default tread depth values for the tire in an unused state. Such baseline or default tread depth values may correspond to the tread depth of the particular model of tire at manufacture. The data stored in the database (700) and corresponding to a particular tire identifier (604) may be included in a response to the VCS (200). Determining whether the tire is in the unused state may then be based on the response to the database (700) query.

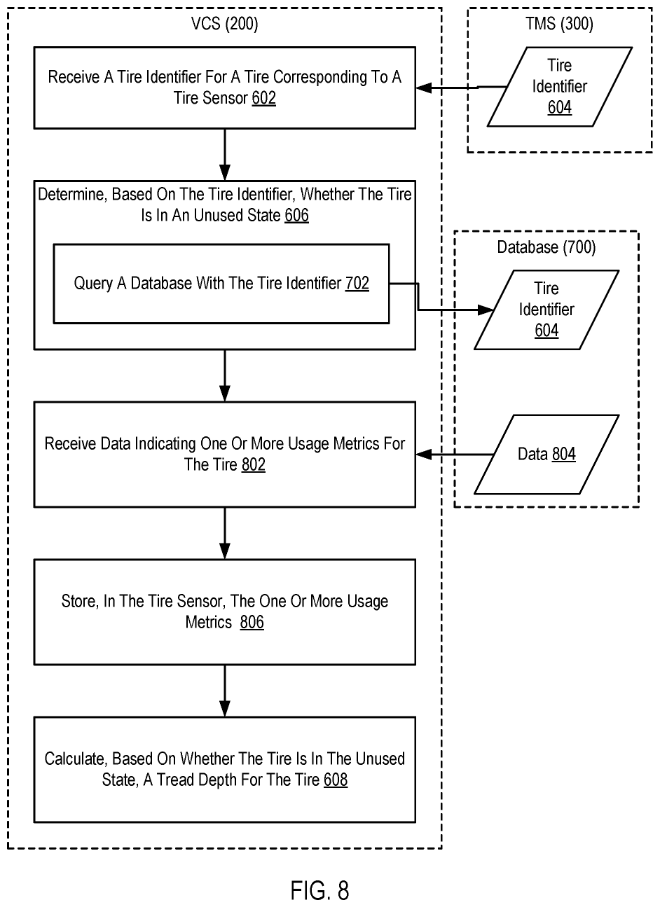

For further explanation, FIG. 8 sets forth a flowchart of an example method to eliminate the need for a manual tread wear system reset in a tire management system according to some embodiments of the present disclosure. The method of FIG. 8 is similar to FIG. 7 in that the method of FIG. 8 includes receiving (602) a tire identifier (604) for a tire corresponding to a tire sensor; determining (606), based on the tire identifier (604), whether the tire is in an unused state by querying (702) a database (700) with the tire identifier (604); and calculating (608), based on whether the tire is in the unused state, a tread depth for the tire.

The method of FIG. 8 differs from FIG. 7 in that the method of FIG. 8 includes receiving (802), from the database (700), data (804) indicating one or more usage metrics for the tire. As set forth above, the database (700) may associate usage metrics for a tire with a corresponding tire identifier (604). Accordingly, in response to the query including the tire identifier (604), the database (700) may provide the data (804) indicating the one or more usage metrics.

The method of FIG. 8 also includes storing (806) in the tire sensor (e.g., the TMS (300)) the one or more usage metrics. For example, assume that a tire was previously installed on a vehicle with a wheel-mounted sensor. The database (700) was updated (e.g., automatically by the previous vehicle or manually) to reflect usage metrics calculated in part based on readings from the wheel-mounted sensor. Further assume that the tire is now installed on a new vehicle with a different wheel-mounted sensor. As the tire does not include a tire-mounted sensor, the tire itself does not include a mechanism to track its usage metrics. Accordingly, the VCS (200) may query the database (700) with the tire identifier to receive the data (804) reflecting the previous usage of the tire on the previous vehicle. The wheel-mounted sensor may then be updated using the data (804) received from the database (700). The usage metrics received from the database (700) may then be used for subsequent calculations of usage metrics.

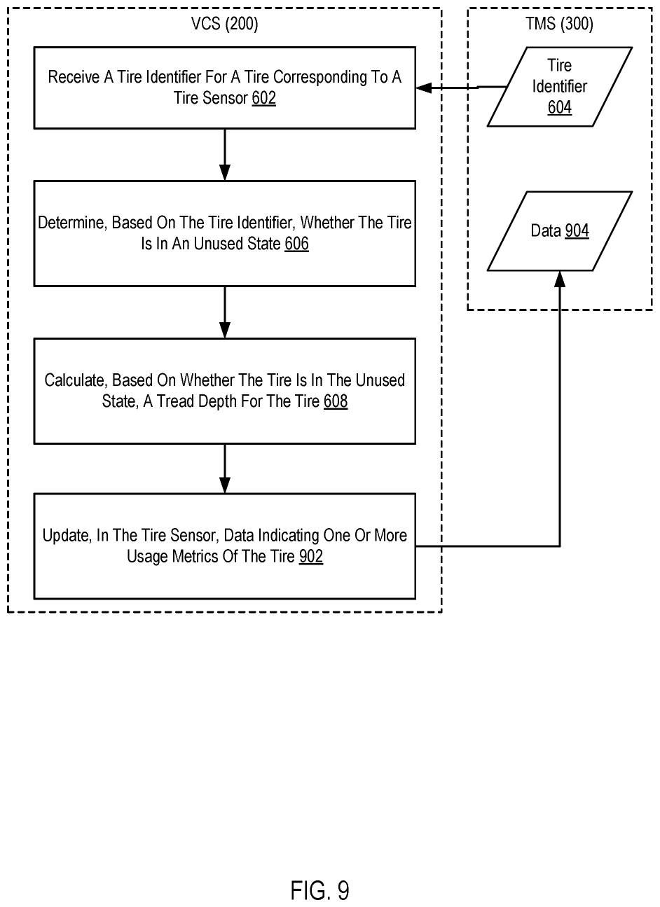

For further explanation, FIG. 9 sets forth a flowchart of an example method to eliminate the need for a manual tread wear system reset in a tire management system according to some embodiments of the present disclosure. The method of FIG. 9 is similar to FIG. 6 in that the method of FIG. 9 includes receiving (602) a tire identifier (604) for a tire corresponding to a tire sensor; determining (606), based on the tire identifier (604), whether the tire is in an unused state; and calculating (608), based on whether the tire is in the unused state, a tread depth for the tire.

The method of FIG. 9 differs from FIG. 6 in that the method of FIG. 9 further includes updating (902), in the tire sensor (e.g., the TMS (300)), data (904) indicating the one or more usage metrics of the tire. The one or more usage metrics may include the calculated tread depth or tread wear for the tire. The one or more usage metrics may include a distance traveled for the tire, a number of rotations of the tire, or other metrics as can be appreciated. Updating (902) the data (904) may include transmitting, to the tire sensor, data indicating usage metrics corresponding to a trip or journey of the vehicle. For example, the VCS (200) may calculate a distance traveled for a tire based on an odometer or GPS. The VCS (200) may include the distance traveled in data transmitted to the tire sensor. The tire sensor may then update a previously stored distance traveled value (including a default or zero value) in the data (904). As another example, the VCS (200) may provide a calculated tread wear to the tire sensor. The tire sensor may then update a previously stored or default tread wear value in the data (904) based on the value received from the VCS (200). As a further example, the tire sensor may update the data (904) for usage metrics measured by the tire sensor independent of the VCS (200), such as a number of rotations.

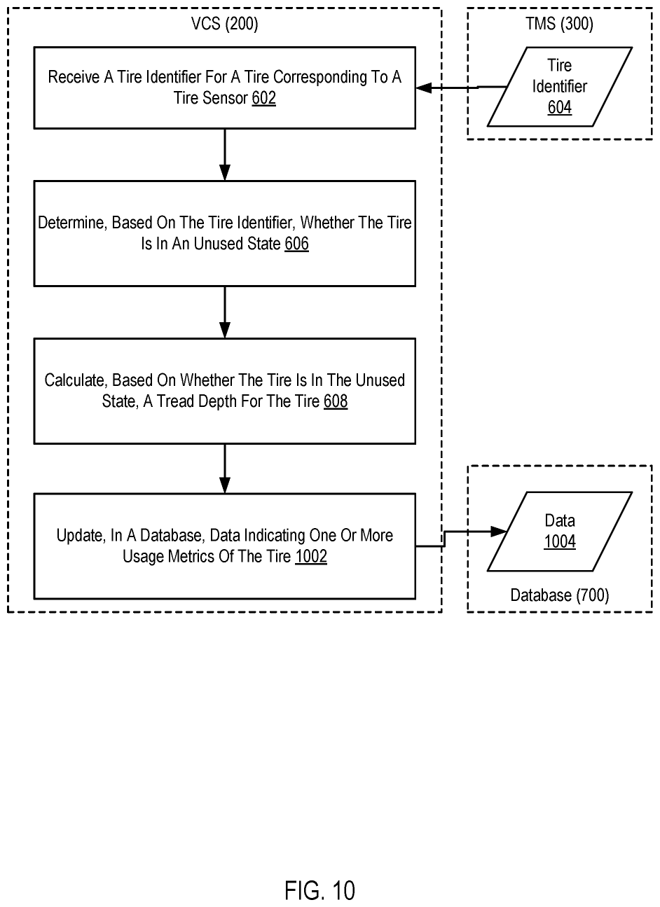

For further explanation, FIG. 10 sets forth a flowchart of an example method to eliminate the need for a manual tread wear system reset in a tire management system according to some embodiments of the present disclosure. The method of FIG. 10 is similar to FIG. 6 in that the method of FIG. 10 includes receiving (602) a tire identifier (604) for a tire corresponding to a tire sensor; determining (606), based on the tire identifier (604), whether the tire is in an unused state; and calculating (608), based on whether the tire is in the unused state, a tread depth for the tire.

The method of FIG. 10 differs from FIG. 6 in that the method of FIG. 10 further includes updating (1002), in a database (700), data (1004) indicating one or more usage metrics of the tire. Such usage metrics may include, for example, calculated tread depth or tread wear values, distance traveled by the tire, a number of revolutions for the tire, and the like. For example, the database (700) may associate particular usage metrics with the tire identifier (704). Updating (1002) the data (1004) may include submitting an update to the database (700) indicating a delta or change in the one or more usage metrics. Updating (1002) the data (1004) may also include submitting one or more updated usage metrics to overwrite previously stored values for the usage metrics.

Exemplary embodiments of the present invention are described largely in the context of a fully functional computer system for eliminating the need for a manual tread wear system reset in a tire management system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, an apparatus, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or other devices to cause a series of operational steps to be performed on the computer, other programmable apparatuses or other devices to produce a computer implemented process, such that the instructions which execute on the computer, other programmable apparatus, or other device implement the functions/acts specified in the flowchart and/or block diagram block or blocks.

Advantages and features of the present disclosure can be further described by the following statements:

1. A method to eliminate the need for a manual tread wear system reset in a tire management system, the method including: receiving, by a vehicle control system of a vehicle, a tire identifier for a tire corresponding to a tire sensor; determining, based on the tire identifier, whether the tire is in an unused state; and calculating, based on whether the tire is in an unused state, a tread depth for the tire.

2. The method of statement 1, wherein the tread depth is included in one or more usage metrics for the tire.

3. The method of statement 1 or 2 wherein the one or more usage metrics further include a number of revolutions for the tire or a distance traveled for the tire.

4. The method of any of statements 1-3 wherein determining whether the tire is in an unused state comprises querying a database with the tire identifier.

5. The method of any of statements 1-4, further including: receiving, from the database, data indicating the one or more usage metrics for the tire; and storing, in the tire sensor, the one or more usage metrics.

6. The method of any of statements 1-5 further including updating, in the tire sensor, data indicating the one or more usage metrics of the tire.

7. The method of any of statements 1-6, further including updating, in a database, data indicating the one or more usage metrics of the tire.

8. The method of any of statements 1-7 wherein the tire identifier is received from the tire sensor.

9. An apparatus to eliminate the need for a manual tread wear system reset in a tire management system, the apparatus configured to perform steps including: receiving, by a vehicle control system of a vehicle, a tire identifier for a tire corresponding to a tire sensor; determining, based on the tire identifier, whether the tire is in an unused state; and calculating, based on whether the tire is in an unused state, a tread depth for the tire.

10. The apparatus of statement 9, wherein the tread depth is included in one or more usage metrics for the tire.

11. The apparatus of statements 9 or 10 wherein the one or more usage metrics further include a number of revolutions for the tire or a distance traveled for the tire.

12. The apparatus of any of statements 9-11 wherein determining whether the tire is in an unused state includes querying a database with the tire identifier.

13. The apparatus of any of statements 9-12, wherein the steps further include: receiving, from the database, data indicating the one or more usage metrics for the tire; and storing, in the tire sensor, the one or more usage metrics.

14. The apparatus of any of statements 9-13, wherein the steps further include updating, in the tire sensor, data indicating the one or more usage metrics of the tire.

15. The apparatus of any of statements 9-14 wherein the steps further include updating, in a database, data indicating the one or more usage metrics of the tire.

16. The apparatus of any of statements 9-15 wherein the tire identifier is received from the tire sensor.

17. A computer program product disposed upon a non-transitory computer readable medium, the computer program product including computer program instructions to eliminate the need for a manual tread wear system reset for a tire management system that, when executed, cause a computer system to perform steps including: receiving, by a vehicle control system of a vehicle, a tire identifier for a tire corresponding to a tire sensor; determining, based on the tire identifier, whether the tire is in an unused state; and calculating, based on whether the tire is in an unused state, a tread depth for the tire.

18. The computer program product of statement 17, wherein the tread depth is included in one or more usage metrics for the tire.

19. The computer program product of statement 17 or statement 18 wherein the one or more usage metrics further include a number of revolutions for the tire or a distance traveled for the tire.

20. The computer program product of any of statements 17-19 wherein determining whether the tire is in an unused state include querying a database with the tire identifier.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method to eliminate the need for a manual tread wear system reset in a tire management system, the method comprising:
receiving, by a vehicle control system of a vehicle, a tire identifier for a tire corresponding to a tire sensor;
determining, based on the tire identifier, whether the tire is in an unused state; and
calculating, based on whether the tire is in an unused state, a tread depth for the tire.

2. The method of claim 1, wherein the tread depth is included in one or more usage metrics for the tire.

3. The method of claim 2, wherein the one or more usage metrics further comprise a number of revolutions for the tire or a distance traveled for the tire.

4. The method of claim 2 wherein determining whether the tire is in an unused state comprises querying a database with the tire identifier.

5. The method of claim 4, further comprising:
receiving, from the database, data indicating the one or more usage metrics for the tire; and
storing, in the tire sensor, the one or more usage metrics.

6. The method of claim 2 further comprising updating, in the tire sensor, data indicating the one or more usage metrics of the tire.

7. The method of claim 2 further comprising updating, in a database, data indicating the one or more usage metrics of the tire.

8. The method of claim 1 wherein the tire identifier is received from the tire sensor.

9. An apparatus to eliminate the need for a manual tread wear system reset in a tire management system, the apparatus configured to perform steps comprising:
receiving, by a vehicle control system of a vehicle, a tire identifier for a tire corresponding to a tire sensor;
determining, based on the tire identifier, whether the tire is in an unused state; and
calculating, based on whether the tire is in an unused state, a tread depth for the tire.

10. The apparatus of claim 9, wherein the tread depth is included in one or more usage metrics for the tire.

11. The apparatus of claim 10 wherein the one or more usage metrics further comprise a number of revolutions for the tire or a distance traveled for the tire.

12. The apparatus of claim 10 wherein determining whether the tire is in an unused state comprises querying a database with the tire identifier.

13. The apparatus of claim 12, wherein the steps further comprise:
receiving, from the database, data indicating the one or more usage metrics for the tire; and
storing, in the tire sensor, the one or more usage metrics.

14. The apparatus of claim 10, wherein the steps further comprise updating, in the tire sensor, data indicating the one or more usage metrics of the tire.

15. The apparatus of claim 10 wherein the steps further comprise updating, in a database, data indicating the one or more usage metrics of the tire.

16. The apparatus of claim 9 wherein the tire identifier is received from the tire sensor.

17. A computer program product disposed upon a non-transitory computer readable medium, the computer program product comprising computer program instructions to eliminate the need for a manual tread wear system reset for a tire management system that, when executed, cause a computer system to perform steps comprising:
receiving, by a vehicle control system of a vehicle, a tire identifier for a tire corresponding to a tire sensor;
determining, based on the tire identifier, whether the tire is in an unused state; and
calculating, based on whether the tire is in an unused state, a tread depth for the tire.

18. The computer program product of claim 17, wherein the tread depth is included in one or more usage metrics for the tire.

19. The computer program product of claim 18 wherein the one or more usage metrics further comprise a number of revolutions for the tire or a distance traveled for the tire.

20. The computer program product of claim 18 wherein determining whether the tire is in an unused state comprises querying a database with the tire identifier.
